(19) United States
(12) Patent Application Publication
(10) Pub. No.: US 2005/0262437 A1
(43) Pub. Date: Nov. 24, 2005

(54) Process for creating and printing customized document at end user computer and printer

(76) Inventors: Dennis M. Patterson, El Cajon, CA (US); Jamie S. Templeton, Laguna Beach, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/057,044

(22) Filed: Feb. 10, 2005

Related U.S. Application Data
(63) Continuation-in-part of application No. 09/556,206, filed on Apr. 24, 2000.
(60) Provisional application No. 60/130,928, filed on Apr. 24, 1999.

(51) Int. Cl. G06F 17/21

(52) U.S. Cl. 715/517

(57) ABSTRACT

A customized document is created at an end user local computer by utilizing a plug-in program installed within a web-browser of the local computer to access and request from a memory device, such as an Internet server, a pre-prepared and unalterable document layout and desired pre-prepared document content, including a graphics image, text, and image and text orientation. The end user in some instances is able to specify the text, select its font type and size, and import end user provided digital image. The graphic image may be edited at the local computer. The document request is fulfilled using the plug-in to interface with the memory device and retrieve the necessary document layout and content, and the user is provided the option of saving the document at the local computer-e-mailing the document, or printing the document using a printer connected to the local computer.

### RELATED APPLICATION

This application claims priority provisional application Ser. No. 60,130,928, filed Apr. 24, 1999, and is a continuation-in-part of U.S. patent application Ser. No. 09/556,206, filed on Apr. 24, 2000.

### BACKGROUND OF THE INVENTION

This invention relates to computerized printing processes. More particularly, the present invention relates to a process for enabling end users to create and print high-resolution documents from their desktop printers.

There are several options currently available to the average consumer seeking printed materials. One option is to purchase the printed materials directly from a provider. However, this option is usually quite expensive and limited to the selection provided. Another option involves utilizing a commercial printer. Artwork and document preparation must typically be done by a graphic artist before submission to the commercial printer. Although a commercial printer can provide very high quality customized materials, it usually takes several weeks to receive the final product and is very expensive.

With the advent of personal computers and the Internet, yet another option allows the consumer to visit a web-site and select from a menu of products having text and drawing options to be printed on the product which are then ordered from the commercial printer from the convenience of a personal computer. As the designs are pre-prepared there is no need for a graphic artist. Such a methodology is taught in Jecha, et al., U.S. Pat. No. 6,247,011.

However, this option provides a limited number of choice selections and can also be expensive. Further, once the product is selected or created for printing it cannot be modified and it typically takes several days or weeks for the commercial printer to finish and send the final product as the product which has been created for printing is uploaded to a server where it is printed professionally, typically using a commercial printing press or the like.

Still another option is the purchase and installation of software products, such as PrintShop Deluxe, Microsoft Publisher, Picassa, etc., which provide clipart graphics which can be imported into documents created by the user. Although these software applications allow the user to print locally on a desktop printer for producing immediate results and lower printing costs, the use of these software applications has several disadvantages. They either take up megabytes of valuable space on the personal computer's hard drive, or comprise several CD-ROMS which must be individually accessed to find and use the desired clipart graphic. Moreover, the software application is operating system-specific, (DOS, WINDOWS or MAC). Also, the quality of the graphics and layouts offered can be poor. Many average consumers find these applications difficult to learn and restrictive in use. Software updates require that new software be periodically purchased and downloaded.

Sieber, U.S. Pat. No. 5,649,216, teaches of such a software product which is downloaded into the user's desktop or otherwise provided on CD-ROM or the like. Text and graphic elements in a page layout are automatically arranged in accordance with a plurality of constraints of a selected page specification. The use selects a piece of artwork from a database of artwork in the program and selects and message text from a data base supporting message texts in the program, and then the software automatically generates a greeting card layout, or the like, in accordance with the artwork specification through selective manipulation of the text and artwork. While easier to use than the aforementioned software products, the primary disadvantage of this software is that the user is constrained to the page layout, artwork, and message texts stored in the database of the software program. Moreover, Sieber does not disclose the ability to import other artwork or digital images from the user.

Yet another option is to print documents and graphic designs directly from the Internet. The ever important influence of the Internet on individuals and businesses is evident from the following reports and statistics. According to a recent report, the number of Internet users in North America is approximately 222 million and it is estimated that 3812 million people are on the Internet worldwide. Over 48 million people visited e-greeting web sites during the month of December 2004. Another report states that there are 1.7 printers for each home personal computer and that an average of over 63 pages, the majority coming from the Internet, are printed each month by these users.

As more people take the time to shop and compare products on-line, they are finding that printing is one of the easiest ways to sort through the wide variety of information. Accordingly, companies conducting business on the Internet must create web sites which are visually appealing. Moreover, printing and paper companies who would traditionally offered greeting cards, announcements, invitations, and the like through brick and mortar establishments are now offering such services on the Internet.

However, current on-line offerings relating to printing present obstacles. Currently, the contents and layout of a web page are typically limited to a screen resolution of only 72 dpi (dots per inch). Pre-formatted documents are sent to the local printer resulting in low resolution prints which may have awkward page breaks within text or even images. No customization, printer capability, or page layout is made available.

Electronically accessed digital imagery may also be in a format which is incompatible with the software on the end user's personal computer so that the user cannot open or print the document. The resolution can vary greatly and may have been set at a level which is incompatible with the desktop printer. For example, the file may have been saved on a desktop scanner at 600 dpi or sent to a service bureau and scanned at a much higher resolution. High resolution images often occupy a great deal of electronic memory. Also, if the high resolution image appears in a one inch square graphic, enlarging the image will reduce its resolution. Furthermore, the user's printer may not have the capability of printing such a high-resolution image.

With the recent popularity of the digital camera, increasingly computer users are using their desktop computers for uploading the digital images taken from the digital cameras into their computers. The uploading or transfer of these images to their computers is a relatively simple task. Saving the images on the hard drive or a CD-ROM for printing either at the local printer or to be taken to a professional printer is also a relatively easy task provided that images are not modified in any way. However, if the user desires to modify the images, the software programs associated with the digital cameras or other programs, such as Photoshop, or the like can be quite complicated to use, take a considerable amount of time to learn how to operate the program, and requires that the user purchase these programs for such editing. Moreover, many of these programs do not enable the digital photographer to import their images into layouts which correspond with paper bought for announcements, greeting cards, etc.

There do exist on-line services wherein the digital photographer after uploading his images from the memory card or digital camera can interact with a web-site server in order to edit the photograph, add text, import the image into a particular document or layout for printing or the like. However, all of these functions are performed at the server itself. Photographs taken with digital cameras are typically imported into a personal computer at approximately 1600×1200 pixels. As 49% of on-line users still use a dial-up connection, the transfer and upload of these images to the web-site server can take a considerable amount of time. Moreover, as the megapixel rating of consumer digital cameras continues to increase, so does the typical image file created by the camera. Further, once the images have been edited and inserted into the desired layout or document, they must be sent back to the end user, also requiring a considerable amount of transfer time. Thus, this process has been found to be cumbersome and time consuming.

It would be advantageous for the personal computer user to be able to customize an electronic document or image for his or her personal needs. For example, the user may want to print an e-greeting card at high resolution and change the text font and orient the text or image to accommodate proper folding and presentation. It would also be advantageous for computer users to share images in a common format which can be altered to meet the customization requirements and limitations of one user's printer or desires. It would also be advantages for users to be able to perform all edits, layouts and text selections, etc. at their personal desk-top computer using a familiar web-browser format, but without having to be connected to the Internet or transfer large image files back and forth between the server. It would also be advantageous for the computer user to be able to print such documents at his or her desktop printer using paper previously purchased by the computer user for that purpose. However, such options are currently not available to Internet users.

Accordingly, there is a need for a process which improves and customizes documents and images taken from the Internet or other networks, for printing on the user's local printer. The present invention fulfills these needs and provides other related advantages.

### SUMMARY OF THE INVENTION

The present invention resides in a process for creating a customized document at an end user computer using a web-browser interface. A plug-in program is downloaded into the web-browser of the end user local computer. The plug-in software can be downloaded by the user from the Internet, previously installed in the local computer's web-browser, or installed by the user from a DVD CD-ROM or other memory device.

The end user then accesses a memory device having a selection of pre-prepared and unalterable document layouts. In one embodiment, the memory device is associated with the end user local computer and comprises a DVD, CD-ROM, or a memory device connected to a port of the end user local computer. In another embodiment, the memory device comprises an Internet website server. The pre-prepared and unalterable document layouts, and in some instances other content such as graphic images, text, and the like is contained within the Internet server or local memory device database.

A customized document request is created using the plug-in by selecting a pre-prepared and unalterable layout from the memory device. Content is also selected, including selecting a graphic image from the memory device database, an end user imported graphics image, text from the memory device database, end user specified text, image and text orientation, and selection of text attributes.

The plug-in interfaces with this memory device through the web-browser, to retrieve the document layout and document content according to the customized document request. The document request is fulfilled according to the request by sending memory device components from the server to the end user local computer.

The components retrieved by the plug-in program from the memory device include graphic images selected from the memory device which are displayed at a first resolution on an end user monitor during the creating step, but a corresponding graphic image having a higher second resolution is sent to the end user local computer during the fulfilling step.

In a particularly preferred embodiment, during the creating step, the end user imports his or her digital images, such as photographs, into the pre-prepared and unalterable document layout at the end user computer. Although the pre-prepared and unalterable document layouts are retrieved from the memory device, the digital photographs remain in the end user local computer during the creating step. The end user may edit the digital photographs at the end user local computer using the plug-in program.

Once the document request is fulfilled, the end user is provided the option of saving the edited photographic image, saving the customized document at the end user local computer, e-mailing the customized document to another computer, or printing the customized document using a printer connected to the end user local computer.

The invention may determine whether the printer connected to the end user printer is capable of printing a customized document, and if so, printing the customized document. If not, the user may be notified of the printer's incapability or improper selection, such as improper paper or printing resolution selection.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is flow-chart depicting the general steps and interfaces between an application in the form of a local memory device or server system and an end-user local personal computer for printing to a local printer in accordance with the present invention;

FIG. 2 is a flow-chart depicting the steps generally taken in accordance with the present invention;

FIG. 3 is a flowchart depicting the steps taken in order to initiate the process of the present invention;

FIG. 4 is a flowchart depicting the steps taken in selecting a document type and content in accordance with the present invention:

FIG. 5 is a flowchart depicting the steps taken in the dynamic creation of a browser web-page;

FIG. 6 is a flowchart depicting the steps taken for importing and modifying images in accordance with the present invention;

FIG. 7 is a flow-chart depicting steps taken in accordance with the present invention; including printing, saving or e-mailing in accordance with the present invention;

FIG. 8 is a flowchart depicting the steps taken for printing documents in accordance with the present invention;

FIG. 9 is a flowchart depicting the steps taken for determining the comparability of the print request with a local printer;

FIG. 10 is a flowchart depicting the steps for submitting a print request to a local computer; and

FIG. 11 is a flowchart depicting the steps taken when e-mailing the document in accordance with the present invention.

### DETAILED DESCRIPTION OF THE PREFERRED EMBODIMENTS

As shown in the drawing for purpose of illustration, the present invention in concerned with a process for creating a customized document at an end user computer using plug-in software operating in a web browser. As will be more fully described herein, the present invention improves the print quality of the document created utilizing Internet type applications, provides a great deal of flexibility and control to the end user in selecting pre-defined document layouts and templates, facilitates the importation and editing of graphic images into the layouts, and enables printing at a local desktop printer.

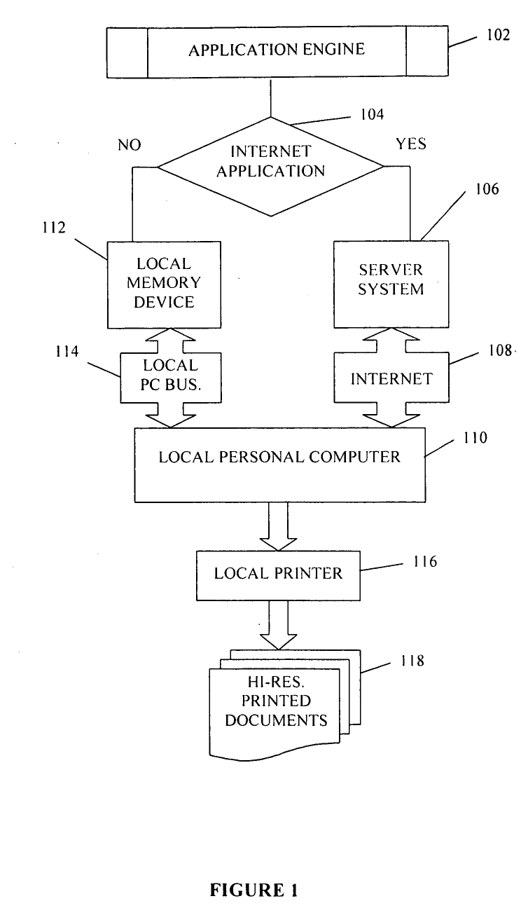

With reference now to FIG. 1, the present invention utilizes an application engine 102 which is referred to herein as a memory device that includes a database of pre-prepared and unalterable document layouts in the form of templates and the like. Such templates may include greeting cards, invitations, announcements or any other such document which will have a pre-defined layout and arrangement for graphic images, text, etc., as will be more fully described herein.

The present invention is particularly adapted for use as an Internet application 104. If the invention is conducted in this manner, a server system 106 interacts with an end user local personal computer 110 through a network connection such as the Internet 108. In typical fashion, the local personal computer 110 interfaces with the remote server system 106 through a worldwide web-site supported by the server.

The Internet is a global computer network that provides the infrastructure for the world wide web. The world wide web is a communication system that is composed of millions of electronic files which contain links to other files stored on various connected computer networks. A computer network includes a group of computers or other such devices linked together in a manner that promotes communication between them. A computer network may include resources such as printers, modems and file servers. It may also include services such as electronic mail (e-mail) or file transfer. A computer network can be a small interconnected system (referred to as a local area network or LAN), or several separate networks that are connected together to form a larger network (wide area network or WAN). The Internet is comprised of many networks which form a large interfaceable network.

The local computer communicates with and accesses the server system via an Internet service provider connection such as a modem utilizing a phone line, cable line or other appropriate communications links. The server system provides information to requesting computers on the network.

One of the most commonly used tools for communication over the Internet is a software application known as a browser. Examples of currently available browsers include Netscape Navigator and Microsoft Internet Explorer and Apple Safari. A browser is a software application that runs on a local computer and provides a user-friendly environment in which a user can interact with a server system via a graphical user interface which allows the user of the local computer to submit various requests or responses. A browser requests, transfers, and displays information that is stored as files on the Internet.

Requests submitted by the local computer are processed by the server system which responds to the request over the Internet by forwarding a request status and the requested information. One of the most commonly accessed resources on the Internet are web-sites or web pages. Web-sites are interactive resources that provide an end user with a graphical interface for either viewing or downloading. A web-site may include a number of graphically displayable pages of information that are linked together, typically with hypertext or hyperlinks. The contents of a web-site can be created using a computer language such as Hypertext Markup Language (HTML) or Extensible Markup Language (XML) and the like. The document or page is text file coded with embedded predefined keywords or tags which are used by the server system in locating information and responding to the local computer's request. Once the end user has viewed the web page, the user can interact with the web page by entering information in a dialog box or clicking on a button, for example.

The present invention can also be implemented in a non-Internet application wherein a local memory device 112 provides the database of pre-prepared and unalterable layouts and other necessary components. The local memory device can be a DVD, CD-ROM, or other electronic device connected to the local personal computer 110, such as through a local PC BUS 114 or port.

In any event, the local personal computer 110 interfaces with either the server 106 or local memory device 112 (collectively referred to herein as memory device or remote application component) in order to create the desired customized document for printing at the local printer 116, resulting in high resolution printed documents 118.

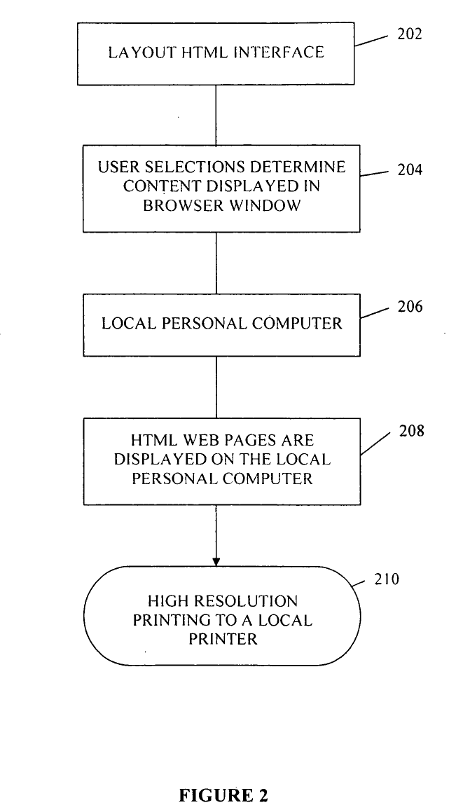

Virtually all personal computers are provided with a web browser when purchased. The web browser presents information, such as web-pages and the like, in a very user friendly manner and are very easy to navigate. The present invention utilizes a plug-in program which works in connection with the personal computer's web browser to effectuate the customized document creation in accordance with the present invention. As illustrated in FIG. 2, the pre-prepared and unalterable document layouts are in an HTML interface 202. The user makes selections to determine not only the template or layout, but also the content displayed in the browser window 204. This occurs at the local personal computer 206. The HTML web pages are transferred from the memory device so as to be displayed on the local personal computer 208. This enables high resolution printing to a local printer 210.

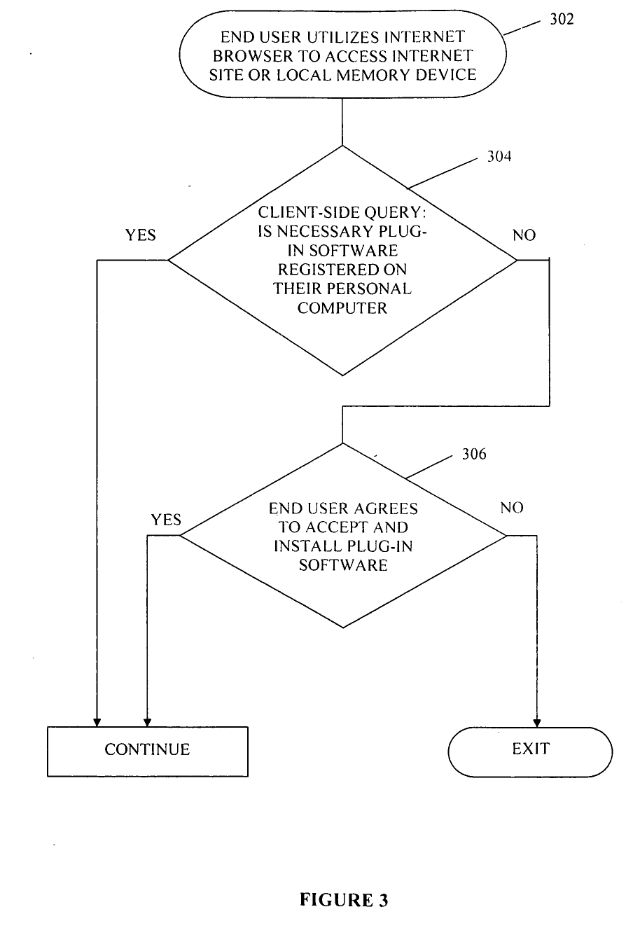

With reference now to FIGS. 3-6, the steps taken in accessing the information in the memory device, the selection of templates or layouts, and content for the creation of a customized document are illustrated. With reference to FIG. 3, the end user utilizing the Internet browser either accesses the desired Internet site, such as a specific URL address to a web-site, or accesses the local memory device connected to the user's local computer 302. A client-side query is made as to whether the necessary plug-in software has been down loaded and registered on the end user's personal computer 304. If not, the end user is provided the opportunity to accept and install the plug-in software 306. If they do not, they can not use the present invention and will not be able to create the customized document.

The plug-in software can be installed as part of the browser when the individual purchases a computer, downloaded from the DVD or CD-ROM or other local memory device, but more typically is downloaded via the Internet when the end user first visits a web-site supported by the present invention. In its most general sense, as will be described more fully herein, the plug-in software is used as a layout tool for selecting document types, importing and editing user's digital images and altering document content and qualities offered on the web-site or through the local memory device. Essentially, the plug-in software interfaces between the local computer and the memory device or web-site server to assist the end user in selecting the pre-prepared and unalterable document layout or templates, text attributes, including text font type, size, subscript, superscript, line spacing, underline, strike-through, all caps, small caps, intercharacter spacing controls (also referred to as Kerning Control) and the like. The plug-in software also facilities importing of graphical images either from the memory device or server or end user provided graphic images, as will be described more fully herein. The plug-in software also provides the tools for not only selecting and importing the content such as text and images, but also in editing the images and text. This occurs in a web-browser setting whether the end user is connected to the Internet or not.

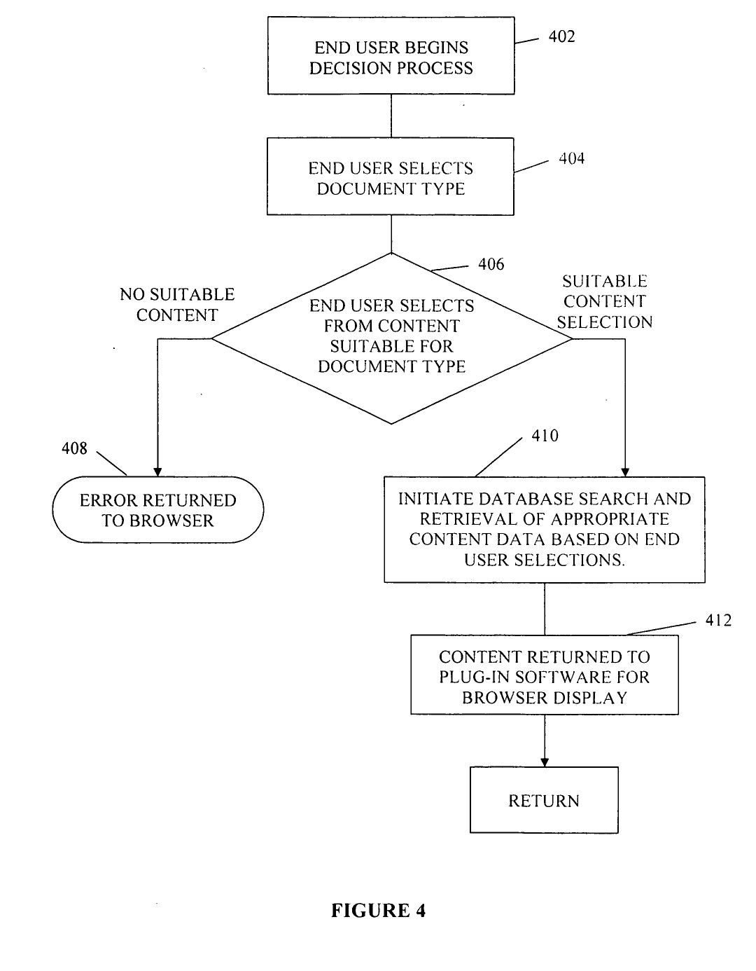

With reference now to FIG. 4, the end user begins the decision process 402 by selecting a document type 404, that is selecting a pre-prepared and unalterable document layout or template type from the data base of available layouts. Such layouts may be specific to the owner of the web-site. For example, if the owner of the web-site is a company that provides birth or wedding announcements, the pre-prepared and unalterable document layouts and templates may be specifically geared to various announcement formats. Alternatively, if the web-site owner is a greeting card company, the pre-prepared and unalterable document layouts may be a variety of greeting card layouts. In other instances the web-site may be affiliated with or owned by a paper company which sells certain types of paper specifically geared to the layout of paper sold at local stores, which are then used to print the greeting cards, announcements, etc., at the end user's local personal computer.

With continuing reference to FIG. 4, the end user selects from contents suitable for the document type 406. The content may be offered at the web-site or in the memory device. If the content is not suitable for the document type, an error is returned to the browser 408. However, if the content selection is suitable, a database search is initiated and the appropriate content is retrieved based on the end user selection 410. The content is then returned to the plug-in software for browser display 412. The content derived from the database is also pre-prepared and at times unalterable so as to fit within the document layouts. For example, when creating a customized greeting card, certain graphic images used on the front of the greeting card may only be able to be used with certain document layouts and not others. For example, some graphic images will be landscaped-based images while others are more appropriately vertically oriented. When selecting a relatively large greeting card layout or template, much more text may be included in the greeting or form or the like as compared to the smaller card. Thus, in some instances certain document content which is selected by the user may not be appropriate for the selected document layout. The end user is then given the opportunity to select a new document layout or different content.

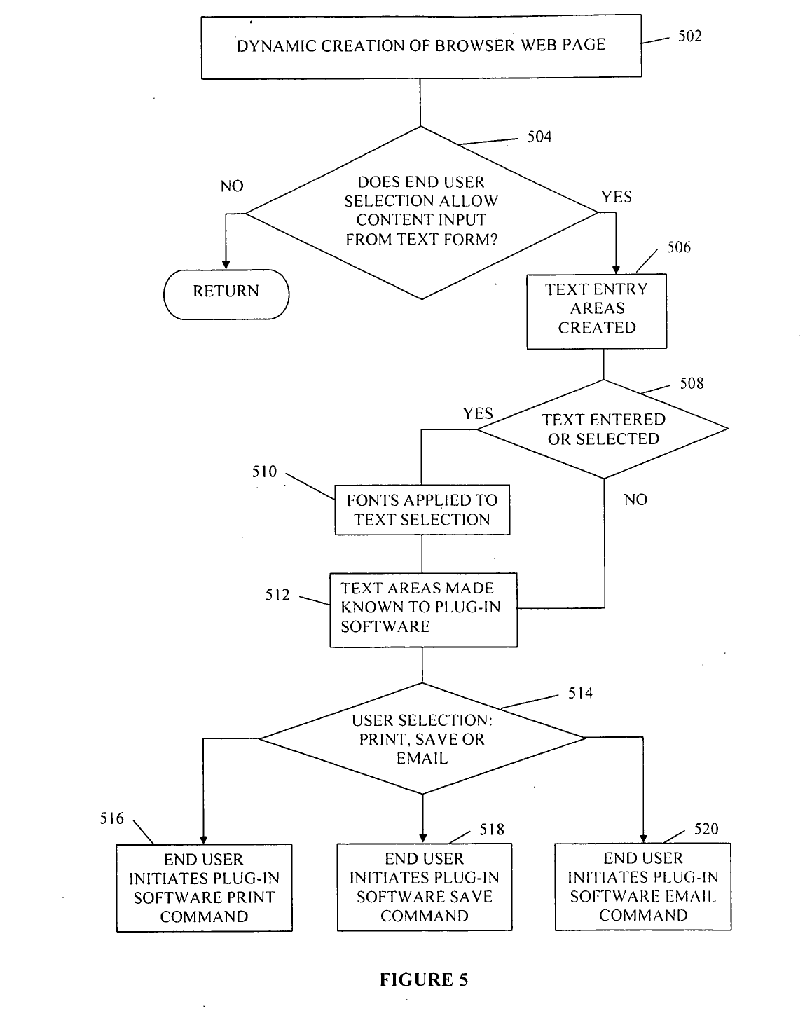

With reference now to FIG. 5, the present invention is not limited to fixed content in the form of text or graphics for insertion into the document layouts, but also preferably allows dynamic creation of the browser web-page 502. In many instances, the end user is allowed to select content to input into the document layout, such as end user specified text 504. If not, an error message or simply the inability to alter the text content in a window or box of the document layout occurs. However, if the end user is allowed to insert text, text entry areas are opened or otherwise created 506. The end user is then allowed to select pre-defined text from the memory device database or enter end user specified text 508. In some cases, the end user is also able to select the text attributes, such as the fonts applied to the text selection or end user entered text, spacing, text size, etc. 510. In either event, the text areas are made known to the plug-in software 512. Using the example of a greeting card, instead of selecting a pre-prepared greeting poem or the like, the end user may personalize the greeting card by inserting his or her own text message. The user may select this option in order to create or open a text entry area for the greeting card. However, the text entry area is pre-defined and positioned on the greeting card in order to preserve the professional look of the resulting document. Thus, the end user may be limited to the text size, spacing or number of characters or words within the text entry area. To increase the number of words, the end user may select a font type and size which will enable a larger message. However, if the message is short, the end user may select a larger text size or increase line spacing so as to fill the text entry area.

With continuing reference to FIG. 5, the user, after the customized document has been created using the pre-prepared and unalterable document layout, and selecting or creating the document content, selects to print, save or e-mail the document 514 As will be more fully discussed herein, the plug-in program interfaces with the memory device to retrieve the document layout according to the end user selection and request, and fulfills the document request by retrieving the necessary content components from either the end user's local computer or the web-site server or memory device. The end user then initiates the plug-in software print command 516, software save command 518, or e-mail command 520, depending upon the user's selection.

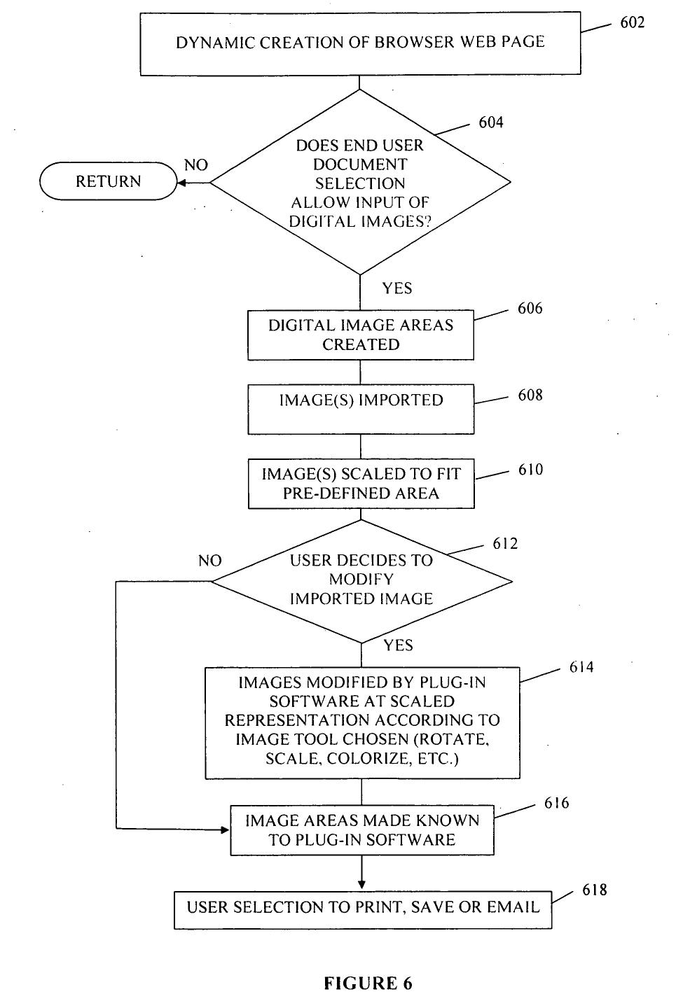

With reference now to FIG. 6, the steps for the dynamic creation of a web browser page or customized document 602 is illustrated wherein the end user is permitted to select or input digital graphic images 604. In some instances, the user is not able to select any digital or graphic images, but rather the images are part of the pre-defined and unalterable document layout. Such may be the case that when selecting a particular greeting card the artwork associated with that greeting card is part of the pre-defined and unalterable document layout. However, preferably the user is allowed to select graphic images and/or input and load his or her own digital images. In this case, the digital image areas are either available through the pre-defined and unalterable document layout or opened or otherwise created 606. The one or more images are imported 608 into the digital image area of the document layout and the image is scaled, if necessary, to fit the pre-defined area 610.

In some instances, the end user is permitted the tools and options to modify the imported image 610. For example, the images may be modified by the plug-in software to be scaled either smaller or larger, rotated, colorized so as to be black and white, color, sepia, or the like. Such editing or modification can be particularly useful when importing digital photographs provided by the end user. The end user can crop, size, rotate (ordinal), move, layer, red-eye removal, auto duotone (multiple selections), adjust brightness, saturation, hue and contrast of the photograph. The editing and importing all occur at the end user s local computer. Thus, there is no need for an Internet connection and the transfer of the photographs and communication over the network which can be cumbersome and time consuming. Furthermore, the end user can create these edits at the local computer with easy to use browser format without tying up the phone line.

The images are modified by the plug-in software according to the image tool chosen 614. Whether the images are modified or not, the image areas are made known to the plug-in software 616 and after the plug-in software has incorporated the various components, either provided by the end user or the memory device or web-site server, the customized document is compiled for user printing, saving and/or e-mailing 618. In the case of graphic images, such as digital photographs, provided by the end user and edited or otherwise modified, the present invention allows the end user to actually save this image alone for later use. The invention also enables the saving on the local computer of the completed customized document.

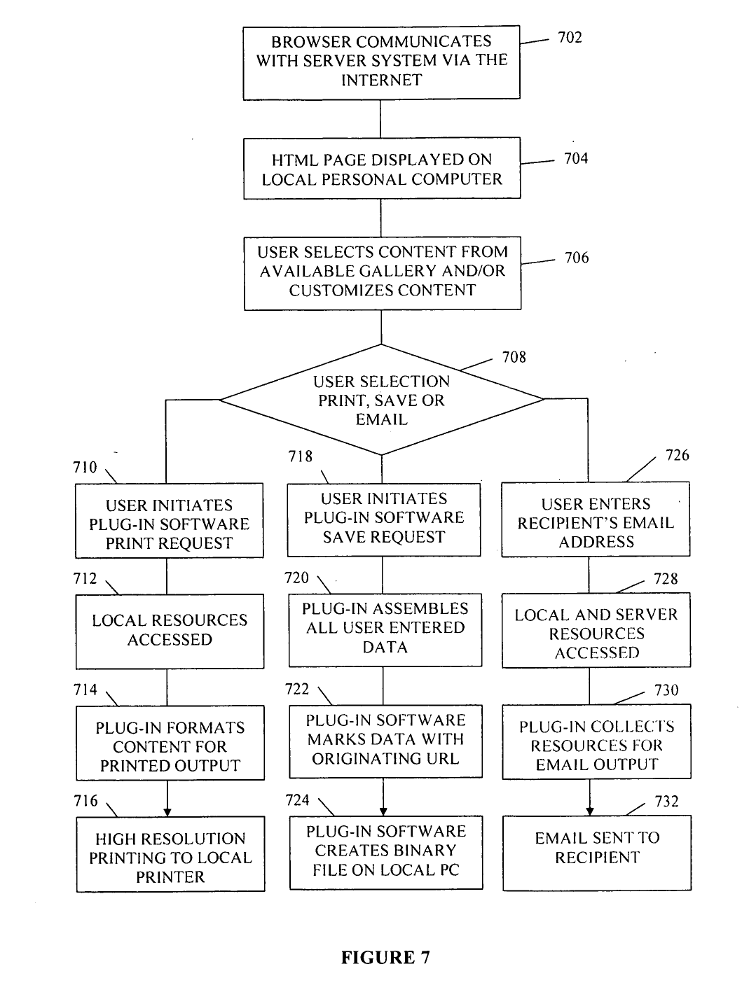

With reference now to FIG. 7, when the browser communicates with the server system via the internet 702, an HTML page is displayed on the local personal computer 704. As described above, the user selects content and templates available either from the database or gallery and/or customizes the content for inclusion in the selected layout 706. When the invention is used in an Internet application, the Internet pages, layouts, graphics and the like selected from the server data base are sent to the local computer and displayed in a typical Internet low resolution—typically approximately 72 dpi. However, graphics provided by the end user such as digital photographs, typically have a much higher resolution such as approximately 1600×1200 pixels. Moreover, the vast majority of desktop printers enables the printing at a much higher dpi than the Internet typically provides when viewing web-pages. Accordingly, after the customized document is created by selecting the pre-defined document layouts, pre-defined graphics and/or text or user specified and provided images and text, the plug-in software retrieves components such as graphics images from the server database which are at a higher resolution in order to fulfill and assemble the final customized document request at the local computer. Thus, this file includes a graphic images, borders, etc., at a much higher resolution which results in a higher quality printed document at the local printer.

With continuing reference to FIG. 7, after the user has created the customized document and the document request has been fulfilled, the user selects to print, save or e-mail the document 708. When printing, the user initiates the plug-in software print request 710. Local resources are accessed 712 to enable the printing. The plug-in software then formats the content for the printed output 714. As discussed above, a high resolution document is then printed at the local printer 716.

When the user elects to save the document, the user initiate's the plug-in software save request 718. The plug-in then assembles all user entered data, and marks the data with the originating URL address 722. The software finally creates a binary file on a local PC, such as the PC's hard-drive, or the like 724.

When the user elects to e-mail the customized documents, the user enters the recipient's address 726. Local and server resources are accessed 728, such as Outlook Express, Web-mail, the creation of a network connection if necessary, etc. The plug-in software then collects resources for the e-mail output 730 and the e-mail is sent to the recipient 732.

In the Internet Application, the invention preferably communicates details of the customized document to the web-site server. This enables the owner of the web-site to determine in how many instances the invention has been implemented, which templates, borders, graphics, etc., are most frequently selected, etc.

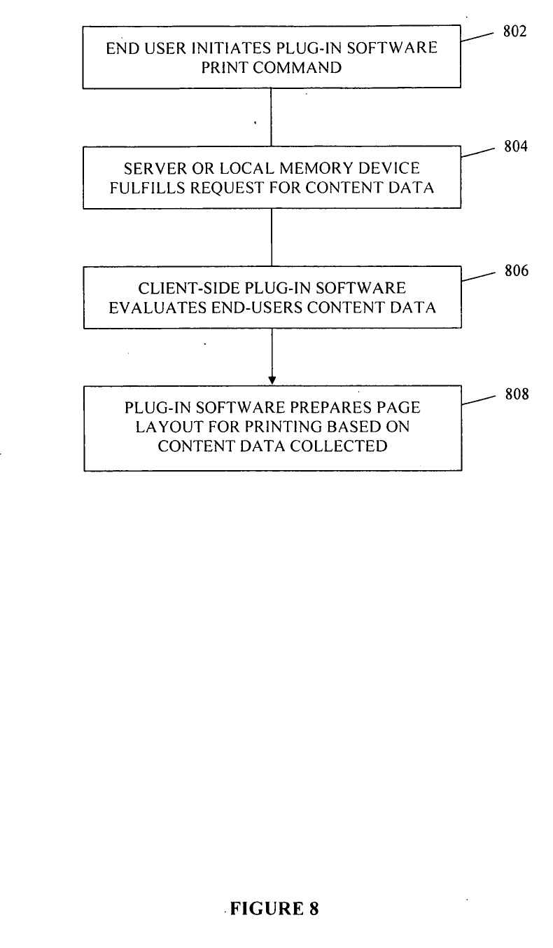

FIGS. 8 through 10 are flowcharts depicting particular steps taken during the printing process using a printer directly connected to the end user's local personal computer. With reference to FIG. 8, the end user initiate's the plug-in software print command 802, as discussed above. The server or local memory device fulfills the request for content data 804. The client-side plug-in software evaluates the end-user's content data 806, and prepares page layout for printing based on the content data collected 808.

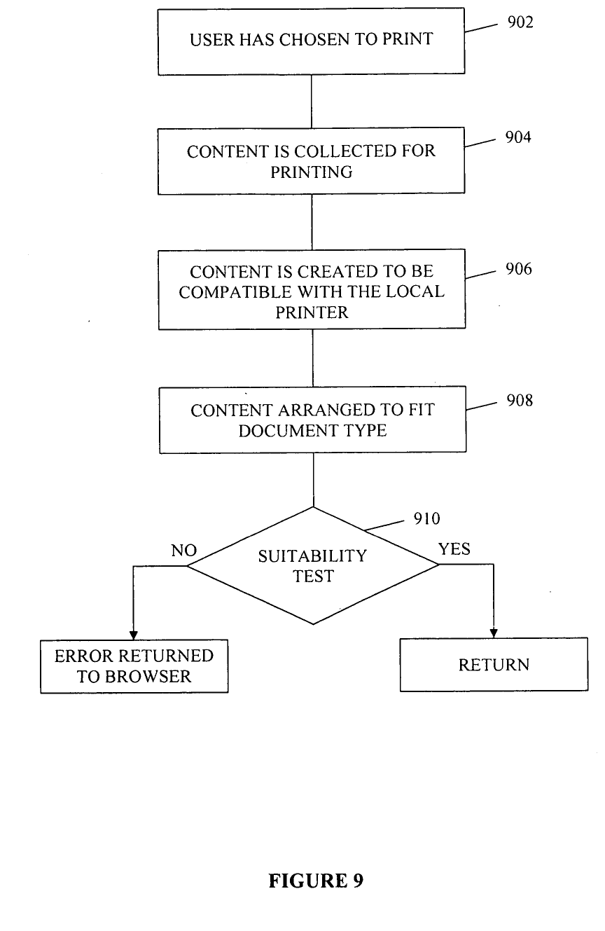

With reference now to FIG. 9, the present invention may also determine the suitability of the fulfilled customized document and the local computer's printer. First, after the user has chosen to print 902, the content is collected for printing 904. If the content in its original form is not compatible with the local printer, the plug-in software preferably creates the content to be compatible with the local printer 906, such as reducing the resolution if the printer is unable to print at the higher resolution, convert color images into black and white images if the printer is only a black and white printer, etc. The content is then arranged to fit into the document type 908. A suitability test 910 is then performed. If the original or modified document is suitable to be printed, it is printed at the local printer. However, if it is not, an error is returned to the browser to inform the end user.

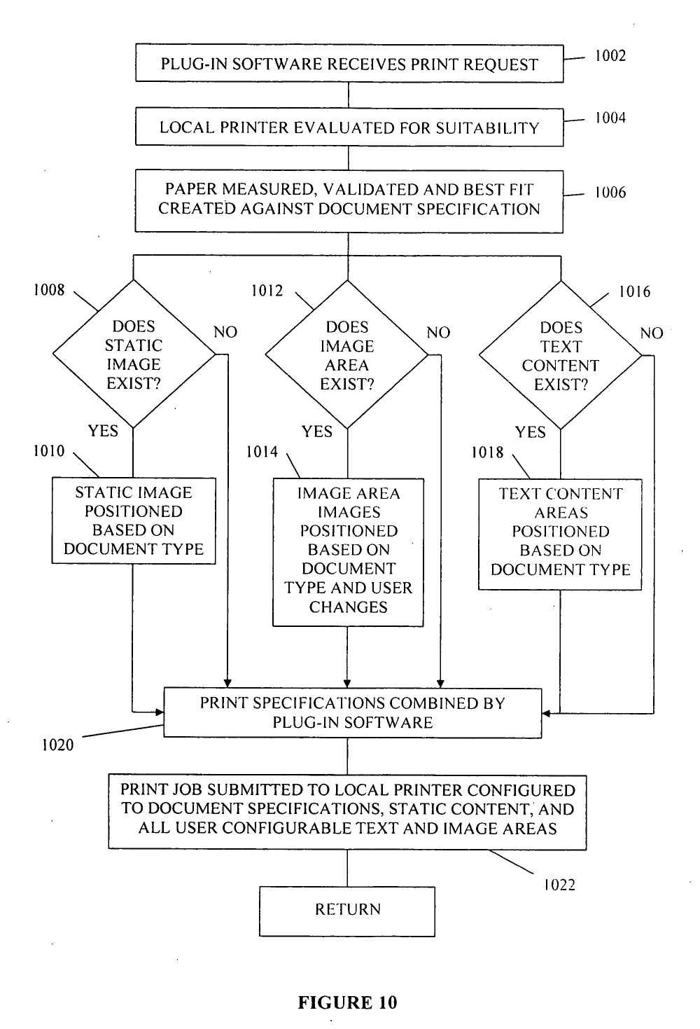

With reference now to FIG. 10, after the plug-in software receives the print request 1002 and the local printer is evaluated for suitability 1004 as discussed above, the present invention may also measure the paper within the printer to validate the paper or create a best fit for the document specification 1006. The plug-in determines whether a static image exits 1008, and if it does the static image is positioned based on the document type 1010. The plug-in also determines if an image area exists, and if it does the image area images are positioned based on document type and user changes 1014. The plug-in also determines whether text content exists 1016. If it does, the text content areas are positioned based on document type as well 1018. All of the print specifications are then combined by the plug-in software 1020 and the print job is submitted to the local printer configured to document specifications, static content, and all user configurable text and image areas 1022.

In certain instances, the measurement and type of paper can be critical. For example, certain requested document layout types may require a very small media size. For example, business cards, announcements, or the like may be printed on individual sheets of very small paper, or contained within perforated borders of a larger sheet of paper. When printing digital photographs or other graphic images of high resolution, it may be desirable to have photographic paper in the printer. In other instances, the document layout or template may be tied directly to a certain paper type in order to print the customized document. The plug-in software can communicate with the printer, printer drivers and other necessary software at the local computer to make these determinations, or insert notices or the like in the web browser to inform the user of these requirements or limitations. For example, although the end user may have created and assembled a customized document appearing on the end user's computer monitor which is pleasing the end user with a resulting printed document may not have the same appearance if the proper paper is not used, the printer cannot support the resolution of the document, etc. In some instances, such as baby announcements or the like, the paper which is purchased may actually include some of the graphic images thereon with other graphic images and/or text selected by the user being printed in relation to the pre-set margins, window and graphic placement on the sheet of paper. Thus, if the proper paper is not purchased, some of these images will not be printed through the printer, although shown on the computer monitor during the document creation process.

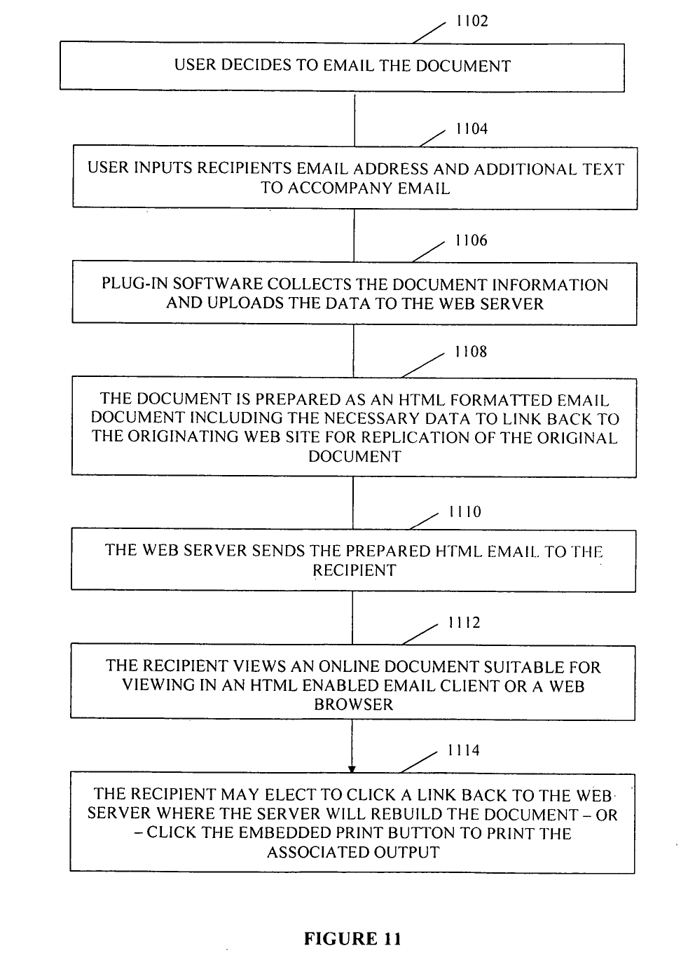

With reference now to FIG. 11, the steps according to the present invention are illustrated when a user decides to e-mail the customized document 1102. The user inputs the recipients e-mail address and additional text to accompany the e-mail 1104. The plug-in software collects the document information and uploads the data to the web-server 1106. The document is typically prepared as an HTML formatted e-mail document, including the necessary data to link back to the originating web-site for replication of the original document 1108.

The web server sends the prepared HTML e-mail to the recipient 1110. The recipient views an on-line document suitable for viewing in an HTML enabled e-mail client or a web browser 1112. The recipient may elect to click a link back to the web server where the server will rebuild the document, or click the embedded print button to print the associated output 1114.

In the instance where the end user selects to save the fulfilled customized document request, the document is saved on the local computer s hard drive or selected disk drive. If the end user e-mails this saved custom document as an attachment to an e-mail, the recipient will view the attachment as a saved file and can print the file directly without having to go back to the web-server to rebuild the document. However, granting the option of rebuilding the document can be advantageous to the recipient as the recipient may not have the same level of printing capabilities as that selected by the sender, and thus may want to rebuild the document according to his or her system capabilities. The recipient may elect to modify the document according to his or her desires, then print or even send the modified document back to the recipient. Such options are helpful in certain situations where a project is being worked on by one or more individual at the same company or if a document preparation company is preparing document for a client, such as brochures or the like.

As those skilled in the art will appreciate, the present invention provides many advantages. The above-described process can be applied to a number of items, including, but not limited to, greeting cards, fliers, letterhead, brochures, labels, certificates, product information and artwork which can be produced and printed from the convenience of a personal computer which is either connected to the Internet or has access to a local memory device containing the invention and its application components. The present invention overcomes the problems of traveling to a store and purchasing costly software which must be downloaded and periodically updated. The user need not be hampered by the poor print resolution of the Internet or the timely and cumbersome uploading and downloading of data between the local computer and the server, as is the case with on-line provided digital photograph editing companies and the like. As the document layouts and templates are created by professional designers, the end result is professional, while still allowing the end user to have the flexibility to import his or her own graphic images, digital photographs, text, etc. Instead of uploading the document to a server where it would otherwise be processed and a professional printer prints the resulting document, the end user is allowed to print the document at his or her local personal computer printer, save the image for later printer, or even sending the document to another for viewing and printing at their local computer.

Although several embodiments have been described in detail for purposes of illustration, various modifications may be made without departing from the scope and spirit of the invention. Accordingly, the invention is not to be limited, except as by the appended claims.

1. A process for creating a customized document at an end user computer, comprising the steps of:
accessing a memory device having a database of pre-prepared and unalterable document layouts;
creating a customized document request utilizing a plug-in program installed within a web browser of an end user local computer by selecting a pre-prepared and unalterable layout and document content, including selecting at least one of a graphics image, text, and image and text orientation;
using the plug-in to interface with the memory device and retrieve the document layout according to the customized document request;
fulfilling the document request using the selected document layout and content to create a customized document; and
providing the end user the option of saving the customized document at the end user local computer, e-mailing the customized document, or printing the customized document using a printer connected to the end user local computer.

2. The process of claim 1, wherein the accessing step comprises the step of accessing a memory device comprising an Internet server.

3. The process of claim 1, wherein the accessing step comprises the step of accessing a memory device associated with the end user local computer.

4. The process of claim 3, wherein the memory device comprises a disk within a disk drive of the end user local computer, a DVD, a CD-ROM, or a memory device connected to a port of the end user local computer.

5. The process of claim 1, including the step of sending components of the customized document fulfilling the customized document request from the memory device to the end user local computer.

6. The process of claim 5, wherein the components include graphics images selected from the memory device which are displayed at a first resolution on an end user monitor during the creating step, and wherein corresponding graphic images having a higher second resolution are sent to the end user local computer during the fulfilling step for saving, e-mailing or printing.

7. The process of claim 1, wherein the creating step includes the step of adding end user specified text.

8. The process of claim 1, wherein the creating step includes the step of selecting text attributes.

9. The process of claim 1, including the step of downloading the plug-in program from the Internet.

10. The process of claim 1, wherein the plug-in program interfaces with the memory device for obtaining the pre-prepared and unalterable document layouts, text, and graphic images and interfaces with the web browser for displaying the pre-prepared and unalterable document layout, graphic images and text of the customized document request to the end user.

11. The process of claim 1, wherein the creating step includes the step of importing an end user provided digital image into the pre-prepared and unalterable document layouts at the end user computer.

12. The process of claim 11, wherein the digital image comprises a digital photograph.

13. The process of 11, wherein the pre-prepared and unalterable document layouts are retrieved from the memory device and the digital image remains in the end user local computer during the creating step.

14. The process of claim 11, including the step of editing the digital image at the end user local computer using the plug-in program.

15. The process of claim 1, including the step of determining whether the printer connected to the end user local computer is capable of printing the customized document, and if so, printing the customized document, and if not, notifying the user of the printer's incapability.

16. A process for creating a customized document at an end user computer, comprising the steps of:
downloading a plug-in program into a web browser of an end user local computer;
accessing an Internet server having a database of pre-prepared and unalterable document layouts;
creating a customized document request utilizing the plug-in by selecting a pre-prepared and unalterable layout from the server database and document content, including selecting at least one of a graphics image from the server database, an end user imported graphics image, text from the server database, end user specified text, image and text orientation, or selection of text attributes;
using the plug-in to interface with the server and retrieve the document layout according to the customized document request;
fulfilling the document request using the selected document layout and content to create a customized document;
sending components of the fulfilled customized document request from the server to the end user local computer; and
providing the end user the option of saving the customized document at the end user local computer, e-mailing the customized document, or printing the customized document using a printer connected to the end user local computer;
wherein the components sent from the server include graphics images selected from the server database that are displayed at a first resolution on an end user monitor during the creating step, wherein corresponding graphic images having a higher second resolution are sent to the end user local computer for saving, e-mailing, or printing.

17. The process of claim 16, wherein the plug-in program interfaces with the server for obtaining the pre-prepared and unalterable document layouts, text, and graphic images selected from the server database, and interfaces with the web browser for displaying the pre-prepared and unalterable document layout, graphic images and text of the customized document request to the end user.

18. The process of claim 16, wherein the creating step includes the step of importing an end user provided digital image into the pre-prepared and unalterable document layouts at the end user computer.

19. The process of claim 18, wherein the digital image comprises a digital photograph.

20. The process of 18, wherein the pre-prepared and unalterable document layouts are retrieved from the server and the digital image remains in the end user local computer during the creating step.

21. The process of claim 19, including the step of editing the digital photograph at the end user local computer using the plug-in program.

22. The process of claim 16, including the step of determining whether the printer connected to the end user local computer is capable of printing the customized document, and if so, printing the customized document, and if not, notifying the user of the printer's incapability.

23. A process for creating a customized document at an end user computer, comprising the steps of:
downloading a plug-in program into a web browser of an end user local computer;
accessing an Internet server having a database of pre-prepared and unalterable document layouts;
creating a customized document request utilizing the plug-in comprising the steps of:
selecting a pre-prepared and unalterable layout from the server database;
importing an end user provided digital image into the selected pre-prepared and unalterable document layout at the end user computer, wherein the pre-prepared and unalterable document layout is retrieved from the server and the digital image remains at the end user local computer;
adding text or graphics into the pre-prepared and unalterable document layout, including selecting at least one of a graphics image from the server database, an end user imported graphics image, text from the server database, end user specified text, image and text orientation, or selection of text attributes;
using the plug-in to interface with the server and retrieve the document layout according to the customized document request;
fulfilling the document request using the selected document layout and imported digital photograph and text or graphics to create a customized document;
sending components of the fulfilled customized document request from the server to the end user local computer; and
providing the end user the option of saving the customized document at the end user local computer, e-mailing the customized document, or printing the customized document using a printer connected to the end user local computer;
wherein the components sent from the server include graphics images selected from the server database that are displayed at a first resolution on an end user monitor during the creating step, and wherein corresponding graphic images having a higher second resolution are sent to the end user local computer for saving, e-mailing, or printing.

24. The process of claim 23, wherein the plug-in program interfaces with the server for obtaining the pre-prepared and unalterable document layouts, text, and graphic images selected from the server database, and interfaces with the web browser for displaying the pre-prepared and unalterable document layout, graphic images and text of the customized document request to the end user.

25. The process of claim 23, wherein the end user provided digital image comprises a digital photograph.

26. The process of claim 25, including the step of editing the digital photographs at the end user local computer using the plug-in program.

27. The process of claim 23, including the step of determining whether the printer connected to the end user local computer is capable of printing the customized document, and if so, printing the customized document, and if not, notifying the user of the printer's incapability.
